(19) United States
(12) Patent Application Publication
(10) Pub. No.: US 2015/0206725 A1
(43) Pub. Date: Jul. 23, 2015

(54) Thermionic Converter

(71) Applicant: Massimo Adriani, Roma (RM) (IT)

(72) Inventor: Massimo Adriani, Roma (RM) (IT)

(73) Assignee: CONSIGLIO NAZIONALE DELLE RICERCHE, Roma (RM) (IT)

(21) Appl. No.: 14/420,884

(22) PCT Filed: Aug. 13, 2013
(86) PCT No.: PCT/IT2013/000227

§ 371 Date: Feb. 10, 2015

(30) Foreign Application Priority Data
Aug. 20, 2012 (IT) RM2012A000415

(51) Int. Cl. H01J 45/00

(52) U.S. Cl. CPC H01J 45/00

(57) ABSTRACT

Thermionic converter with a linear arrangement of the components, suitable for the direct conversion of solar energy into electrical energy and the combined generation of heat and energy, including an elongated vacuum tube which houses a cathode and at least one anode, the cathode and the at least one anode being arranged longitudinally alongside each other along the vacuum tube, wherein the cathode is suspended centrally inside the vacuum tube at at least one end which forms a corresponding current output of the cathode, wherein the cathode is a cathode in the form of a spiral.

### FIELD OF THE INVENTION

The invention relates to a device for capturing solar energy and converting it from radiating form into electrical and thermal energy, which comprises a cathode in the form of a spiral designed to generate an axial magnetic field able to deflect the electrons emitted from the cathode towards the anodes arranged radially.

The object of the invention is to obtain a high conversion efficiency and simple implementation in systems for concentrating solar energy arranged in linear rows.

### PRIOR ART

The present-day thermionic conversion systems consist mainly of three types: small-volume converters; electric-field converters; caesium vapour converters.

All these types of converter operate reducing as far as possible, from 0.3 mm to a few microns, the distance between the electrodes and using an electric field in order to lower the working function of the cathode and/or the ionized caesium vapours, so as to reduce the spatial charge between the electrodes.

For conversion purposes a thermodynamic cycle is used where the thermal energy, converted into the kinematic energy of the electrons, is extracted from them by means of the inverse electric field, slowing them down until they strike the anode, where the residual kinetic energy is dissipated by the cooling system.

The types of converters described above have a major defect: most of the energy used to heat the cathode, at the temperature for thermionic emission of the materials, passes directly from the cathode to the anode by means of irradiation and is dissipated by the cooling system owing to the directly facing and close arrangement of the surfaces of the two electrodes.

Since this energy is not transported by the electrons, it is energy which is lost by the system and this drastically reduces the conversion efficiency.

Two strategies are principally employed in these devices in order to overcome this problem:
reducing the thermionic emission temperature by choosing materials with a lower working function and reducing the distance between cathode and anode (capturing electrons with a smaller kinetic energy);
reducing the working function of the cathode by means of application of an electric extraction field via a photolithographic process carried out on the surface of the cathode and deposition of an extraction grid at a distance of a few microns from the emitting surfaces. The applied electric field reduces the working function of the cathode, allowing thermionic emission also at ambient temperature. Both the methods increase the conversion efficiency of the respective devices, reducing the irradiating emission of the cathode and therefore the energy lost, but, on the other hand, drastically reduce the thermodynamic efficiency which is defined by the temperature difference between anode and cathode; the product of the two efficiencies gives the total efficiency of the device.

In the thermionic devices of the prior art a number of solutions comprising cathodes with a helical form have been proposed.

For example, the patent application GB 2192751 describes the structure and the method of manufacturing a number of cathodes for thermionic devices. Collimation of the electron beam is obtained also by means of a cylindrical form of the cathode and also by means of compensation of the magnetic field generated by the cathode heating current, achieved by the arrangement of the conductors along a path consisting of two rows with parallel spirals where, during the supply circuit output, the current flows in one direction along a first spiral and, during the supply circuit return, the current flows in the opposite direction along a second spiral immediately adjacent to the first spiral. This thus produces two adjacent helical paths along which the heating current flows in opposite directions, thereby compensating for and eliminating the magnetic field generated by the current. The same document GB 2192751 describes similar solutions in which the magnetic field is eliminated by planar arrangements of the conductors with a spiral form wound in a double row or parallel serpentines.

### SUMMARY OF THE INVENTION

The aim of the present invention is to exploit in an economically advantageous manner the solar energy obtained from direct irradiation in concentration plants for the production of electric energy, by increasing the power converted per unit of surface area exposed by means of an increase in the electric conversion efficiency.

In order to achieve this result a high-temperature thermionic converter designed to increase the efficiency thereof is used, whereby it is proposed:
reducing the energy lost through irradiation by using a more efficient insulation system which is formed by means of vacuum radiation screens so as to reflect most of the energy irradiated by the cathode, back onto the cathode;
reducing the energy exchanged between cathode and anode by direct irradiation by means of the relative positioning of the surfaces, aligning them in the same plane in such a way that, not directly facing each other, they are able to exchange energy on a very small scale;
optimizing the electrical connection of the cathode by means of lengthening of the output path so as to limit the losses through thermal conduction via the electrical conductors and lower the output temperature of the terminals; and
deflecting in an efficient and simple manner the electrons emitted by the cathode towards the anodes.

These measures enable the emitter cathode to operate at its maximum permissible temperature which may vary for example between 2300° C. and 3100° C. for tungsten, carbon, tantalum or rhenium cathodes, but which may also have a different temperature range in the case of cathodes made of other materials, thereby drastically reducing the system losses due to irradiation and increasing and maximizing the thermodynamic efficiency and therefore the total efficiency.

The device according to the invention is a thermionic converter with a linear arrangement of the components, suitable for the direct conversion of solar energy into electrical energy and at the same time suitable for the combined generation of heat and energy, in the form of an elongated tube preferably under a vacuum, made of glass or other transparent heat-stable material with a cathode wound spirally, designed to generate an axial magnetic field able to deflect the electrons emitted by the cathode towards at least one anode arranged longitudinally and radially with respect to the cathode itself, which is mounted in the centre of the tube.

The thermionic converter according to the invention advantageously also comprises means for directly cooling the at least one anode and means for electrical connection of the cathode and the at least anode from the inside to the outside, so that the converter is able to work at the maximum temperature which can be withstood by the cathode, transfer of the heat by means of conduction being limited by means of a longer path for connection to electrical connectors and all the surfaces of the cathode and the at least one anode (which has a flattened form with two main faces) being used as surfaces for emitting and absorbing electrons.

The converter according to the invention further comprises an optical access window along a surface area of the tube, which forms an optical element of the concentration system (which may be in the form of a cylindrical lens or other types of lenses or concentration prisms which can be formed either by varying the form of the tube wall or by means of additional devices) allowing the use of systems for linear concentration of the solar energy such as cylindrical/parabolic mirrors. The cathode is made of a conductive refractory material and is suspended inside the tube with an elongated spiral form so as to constitute the element for capturing the solar energy, onto which the sunlight is directly focused in order to perform thermionic conversion, without any intermediate means for transfer of the heat, and wherein the electrical connections with the exterior form a path made longer so as to limit the losses due to thermal conduction.

The spiral form of the cathode allows to compensate for the thermal expansion of the cathode itself.

Moreover, said at least one anode is preferably provided with one or more deflection magnets for generating a magnetic field.

The thermionic converter according to the invention may also be provided with grid electrodes for generating electric fields in a manner similar to the converters of the prior art.

The tube is advantageously provided with radiation screens designed to limit the radiation heat exchange with the exterior; moreover the radiation heat exchange between the cathode and said at least one anode is limited by the relative positions and orientations of the cathode and said at least one anode which face each other with their respective profiles so as to produce relative positioning where there is minimum irradiation and minimize the view factor or coefficient, for example producing a view factor which varies preferably between 0.001 and 0.35, more preferably between 0.001 and 0.1, more preferably between 0.001 and 0.5.

The converter has an access opening for the tubes for cooling said at least one anode passing through flexible diaphragms preferably at both the opposite ends of the tube and electrical wires for connection, preferably to both sides, so as to allow easy installation of a plurality of units aligned in rows by means of hydraulic and electrical connections. In particular, the converter comprises preferably at least one longitudinally flattened hollow tube so as to form two flat faces which are inclined with respect to each other and arranged symmetrically with respect to a plane, and this least one hollow tube is mounted so that this plane of symmetry passes through a diameter of the cathode. This at least one hollow tube has the triple function of: acting as electrodes for connection with the exterior, forming the conversion surface of at least one anode with a low view coefficient between the cathode and the anode/anodes, and cooling, by means of circulation of cooling fluid, the anode/anodes so as to operate at a temperature which is as low as possible, preferably <400° C., typically 50-100° C. or less, while still ensuring efficient cooling, allowing at the same time recovery of heat for low-temperature uses. By way of a non-limiting example, the converter may comprises (at least) one pair of these flattened hollow tubes longitudinally mounted diametrally along the sides of the cathode. The conversion surfaces of the at least one anode may be lined with a functional layer which facilitates, for example, capture of the electrons. Among such linings a barium lining may be advantageous.

The tube of the converter is a high-vacuum tube, but may also be a caesium-vapour tube and comprises radiation screens along the inner surface, except for the optical access window (referred to below also as access window) in order to minimize the radiation losses.

The converter further comprises mechanical locking means at one of—or preferably at both—the ends of the tube for exact alignment of the elements and for positioning the converter with respect to the optical concentration system.

The converter can be used in combination with an optical system for concentrating the energy inside or outside the tube. Other objects of the invention will become clear from the description below.

### BRIEF DESCRIPTION OF THE FIGURES

FIG. 1 shows: an overall axonometric perspective view of an application of a first embodiment of the thermionic converter according to the invention, illustrating by way of a non-limiting example the positioning of a number of units of the thermionic converter 1 arranged along the focal line of a row of cylindrical/parabolic mirrors 2.

FIG. 2 shows a cross-sectional view of the first embodiment of the thermionic converter with cathode having a cylindrical cross-section.

FIG. 2A shows a cross-sectional view similar to that of FIG. 2 with a cathode having a longitudinally flattened cross-section 28.

FIG. 3 shows an axonometric perspective view (FIG. 3a), an axonometric perspective view sectioned longitudinally along two orthogonal axial planes (FIG. 3b), a side view (FIG. 3c), a sectioned side view (FIG. 3d), and a cross-sectional view (FIG. 3e) of the cathode 24 of the thermionic converter according to FIG. 2.

FIG. 4 shows a side view (FIG. 4a), a longitudinal section (FIG. 4b) and a cross-section (FIG. 4c) along the plane B-B of FIG. 4a of the cathode in a second embodiment of the thermionic converter according to invention.

FIG. 5 shows a side view (FIG. 5a) and a cross-section along the plane C-C of FIG. 5a (FIG. 5b) of the cathode in a third embodiment of the thermionic converter according to invention.

FIG. 6 shows a longitudinal section along the plane A-A of FIG. 2 of the thermionic converter.

FIG. 6A is the same view as FIG. 6, with the addition of a heat bridge 30 on the output terminals and a further screen 31.

FIG. 7 shows a side view of the cathode 27 in a fourth embodiment of the thermionic converter according to the invention.

FIG. 8 shows a side view (FIG. 8a), a longitudinal section (FIG. 8b) and a cross-section (FIG. 8c) along the plane B-B of FIG. 8a of the cathode in a fifth embodiment of the thermionic converter according to invention with cathode 28 having a flattened cross-section.

### KEY FOR FIGURES

1 Series of row-mounted converters
2 Cylindrical/parabolic mirrors with 40° opening
3 Vacuum tube
4 Access window
6 Cooled anodes
7 Double spiral for reducing conduction losses of cathode
8 Series of permanent deflection magnets
9 Reflective radiation screens
10 Auxiliary containing grids
11 Deflection grids
12 Locking and centring reliefs
13 Control grids
14 First acceleration, deflection and compensation grids
15 Second acceleration, deflection and compensation grids
16 Anode field screening grids
17 Holes for receiving the cooling tubes
18 Anode cooling tubes
19 Discharge tube
20 Main hole for receiving cathode terminals
21 Electrical connection base
22 Resilient diaphragm for receiving the anode cooling tube
23 Resilient diaphragm for receiving the end of the cathode, for compensation of heat expansion and for glass/metal connection
24 Cathode in the form of a cylindrical spiral having two current outputs at the two ends and opposite double-start constant-pitch winding, formed by means of machining of a solid cylinder
25 Cathode in the form of a cylindrical spiral having a current output at one end and single-start variable-pitch winding, formed by means of machining of a solid cylinder
26 Cathode in the form of a cylindrical spiral having two current outputs at the two ends and opposite single-start variable-pitch winding, formed by means of machining of a solid cylinder
27 Cathode in the form of a cylindrical, single-start, constant-pitch spiral, formed by a wire wound by means of spiral bending
28 Cathode in the form of a flattened spiral
30 Heat bridge
31 Reflective screen in the form of an axial radiation disc.

The dimensions, proportions, number of grids, optical element of the access window and materials may vary, subject to the particular working relationships described below.

The drawings shown are not constructional drawings, they contain sufficient information to allow the preparation of constructional drawings; they are to be regarded as being purely exemplary and intended to illustrate the text, and not to limit the scope of the invention.

### DETAILED DESCRIPTION OF THE INVENTION

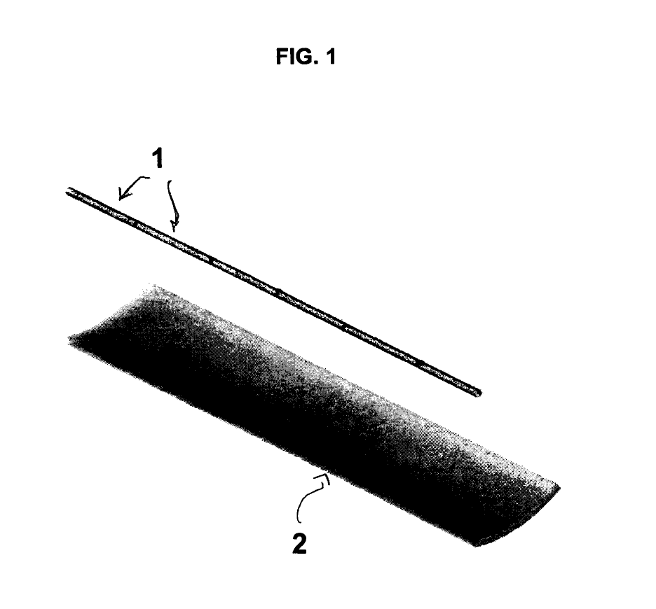

In this description reference is made to FIGS. 1-8, citing the “view factor” which, between a first and second body, is defined as being the fraction of radiating energy which leaves the first body and reaches the second body. On the basis of this definition the view factor is a non-dimensional parameter which is variable between 0 and 1. There exist tables, known to the person skilled in the art, for calculating the view factors in various configurations.

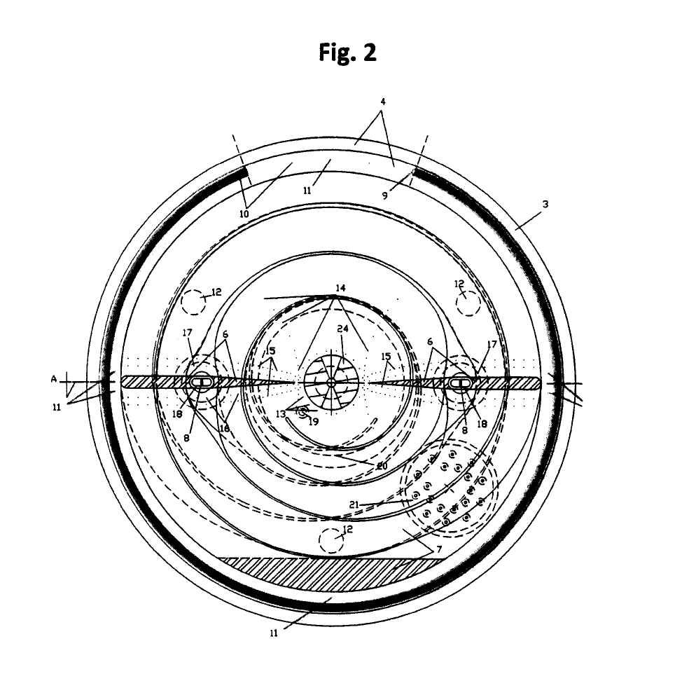

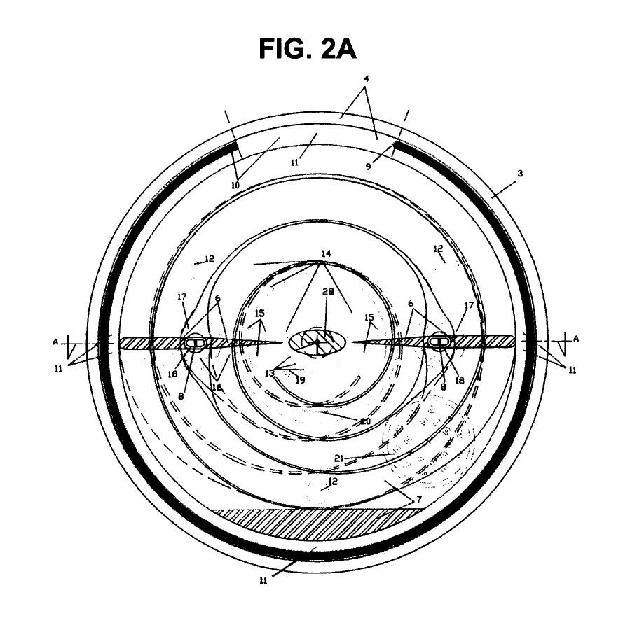

With reference to FIG. 2, it can be seen that a first embodiment of the linearly extending thermionic converter according to the invention comprises an elongated high-vacuum tube 3 which is made of heat-stable transparent material, for example glass with a radiation transmission which is as broad as possible and stabilized by means of annealing. The tube 3 advantageously has an elongated cylindrical form with dimensions, i.e. diameter 200 mm and length 1000 mm, indicated only by way of example.

Along one segment of the cylinder surface, the tube 3 has an optical access window 4, advantageously with an elongated rectangular form, parallel to the longitudinal axis of the tube 3, made of the same transparent material as the tube, covering a segment preferably of 40° which forms, with the shape of the wall, an optical element which cooperates with the system for focusing the solar energy on the cathode 24 and which allows the use of linear systems for concentrating the energy derived from an external source, such as solar energy, for example of the type consisting of cylindrical/parabolic mirrors 2 (shown in FIG. 1), multiple or prismatic mirrors, single or multiple lenses, Fresnel or prismatic lenses (which lenses may be incorporated in the window 4), or any other concentration system which is typically positioned outside the tube 3, but advantageously also inside in the case of miniaturized converters. This window 4 may be shaped in the form of a lens (not shown) or other optical element and may be surface-treated internally or externally, for example by means of deposition of conductive, anti-reflection, selective transmission, insulating, hydrophobic, self-cleaning, protective or self-regenerating layers, and/or any other type of functional treatment of the surface or surfaces known per se.

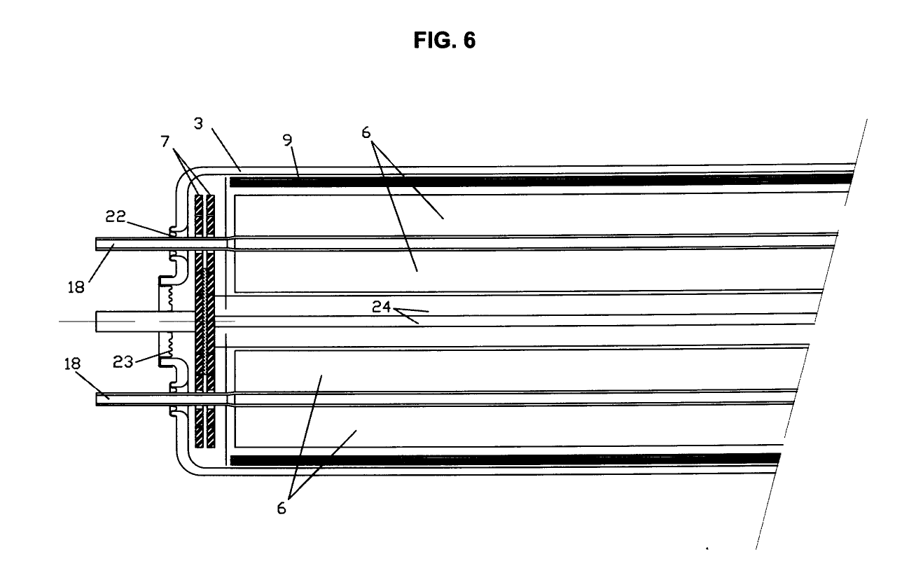

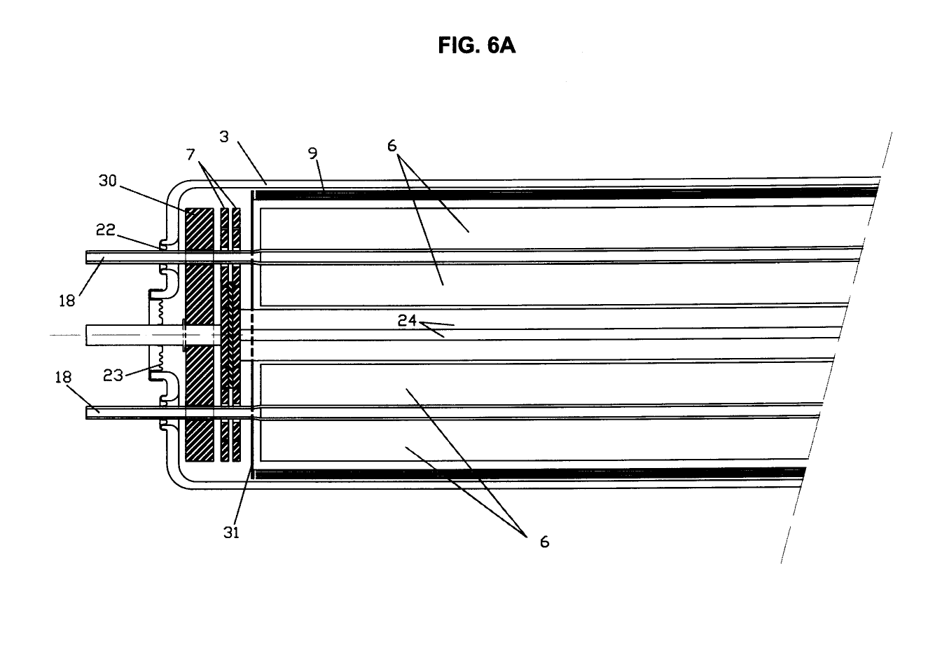

Each of the two ends or bases of the tube or cylinder has a number of flanged holes 17 and 20 for mounting respective resilient diaphragms 22 and 23 for receiving a cathode 24 or at least one anode 6 (in the embodiment shown in FIGS. 2 and 6 the anodes are two in number) and a number of external reliefs 12 (or cavities) for exact alignment of the parts and positioning of the converter with respect to the optical concentration system and mechanical locking thereof. As mentioned, these holes 17 and 20 are advantageously fitted with flexible sheet-metal diaphragms 22 and 23 having a low expansion factor, and concentric undulations for offsetting thermal expansion of the ends of the cathode 24 and the cooling tubes 18, connected to the glass so as to maintain the vacuum. Holes for receiving the cathode 24, the discharge tube 19 and the tubes 18 for cooling the anodes 6 integrally connected thereto (for example by means of welding) are formed in the diaphragms 22 and 23.

It should be noted that the dimensions are not indicated since they may be varied depending on the requirements, the different models and the plant characteristics.

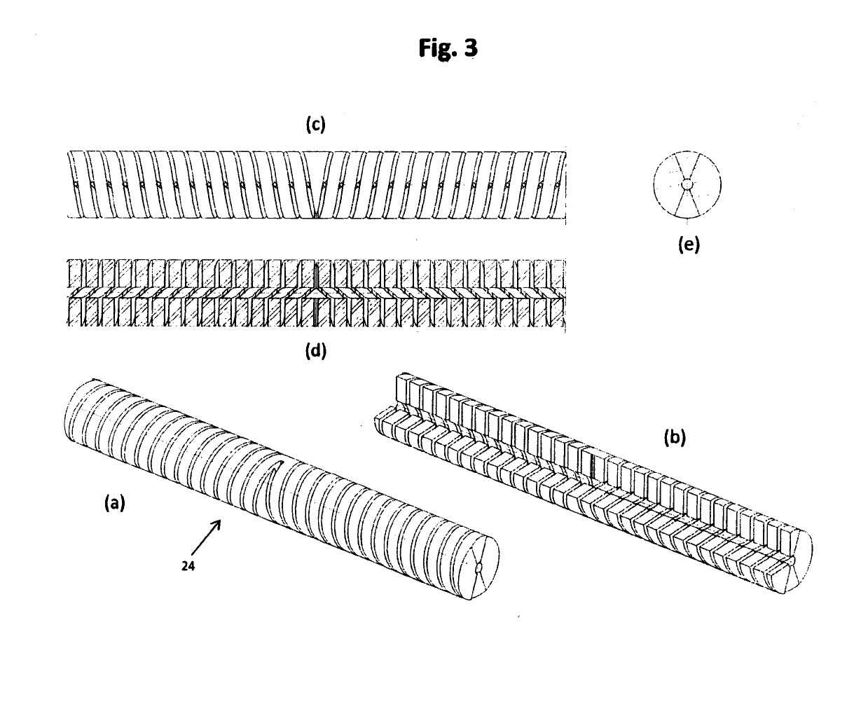

The tube 3 houses internally, in a longitudinal arrangement, a cathode 24 shown in detail in FIG. 3. The cathode 24 is made of conductive refractory material (such as tungsten or graphite), with two current outputs at the two ends and opposite double-start constant-pitch winding.

The cathode 24 may be obtained from a solid cylinder by means of a spiral cut which, starting from the surface of the cylinder, engages slightly more than fifty percent of the diameter (namely without exiting at the opposite end of the diameter). It is thus possible to obtain a single-conductor solenoid with the maximum cross-section which can be obtained from the cylinder itself. In particular, owing to its double-start winding, the cathode 24 may be easily produced from a round bar by means of a through-cut performed by means of wire electro-erosion.

The cathode 24 may be manufactured in different ways using other methods. For example, a ceramic cylinder may be firstly lined with a conductive, metallic or ceramic, conductive refractory material, having a limited working function, and then a thin helical cut may be formed along the cylinder, starting from one end, by means of a thin electro-erosion cutting wire or lathe-machining, or milling, or machining with abrasives, or sintering, or laser cutting, or ultrasound cutting, depending on the material to be machined, also without reaching the opposite end. Alternatively, it is possible to use a water-cutting and/or chemical erosion cutting process.

Owing to the form of the cathode 24 (i.e. with an opposite double-start constant-pitch winding) it is possible to generate, during operation of the converter, an axial magnetic field which decreases gradually in intensity towards the centre, which magnetic field is due to the thermionic-emission supporting current which flows along the two opposite sections of the cathode 24 in opposite direction, owing to the opposite winding directions of the two mirror-image halves of the same cathode 24. This axial magnetic field effectively helps achieve deflection of the electrons emitted towards the lateral anodes in the converter according to FIG. 2.

As shown in FIGS. 2, 6 and 6A, the cathode 24 extends along the entire length of the vacuum tube, along a directrix parallel to the axis of the tube itself, being positioned longitudinally in the centre and suspended at both ends by means of an elongated path for the connection to the electrical output terminals, which may be arranged inside the vacuum tube 3 in any way, for example a straight, bent, interlacing or wound path. The cathode 24 is heated to a high temperature by means of irradiation directly by the radiation (which is preferably concentrated), e.g. sunlight, which enters into the window 4 without intermediate means for transmission of the heat. Via the suspension means, the cathode 24 passes out of one or both the sides of the vacuum tube 3 so as to allow the assembly of several converters in a row by means of external electrical connections.

As shown in FIG. 2, the suspension system at each end of the cathode 24 is formed by means of a conductor, which may be made of the same material as the cathode 24, comprising two spirals 7 with winding directions coinciding with and in the same sense as the adjacent portion of the cathode, so as to generate a magnetic field which is added to the magnetic field generated by the cathode. In this way, the suspension system at each end of the cathode 24 also acts as an electrical connector for the end, increasing the length of the path of the electrical output terminals, in order to reduce the dispersions due to thermal conduction of the cathode 24 and at the same compensating for the longitudinal thermal expansion of the said cathode 24. Therefore, the cathode 24 is electrically connected by means of double-spiral conductors 7 so as to increase the length of the heat conduction path and limit the associated heat losses due to conduction occurring via the electric terminals which connect it to the exterior. The spiral conductors 7 may be formed integrally with the cathode. The spiral conductors 7 pass through the flanges and the person skilled in the art will know how to take into account the thermocouple and Peltier effects when designing the electrical connections for series connection of several devices and for the connections to the load.

Advantageously, a heat bridge 30 (shown in FIG. 6A) may be provided inside or outside the tube, for management of the thermal flows on the outer electric joints. The heat bridge 30 is isolated electrically on the anode cooling tubes 18.

Other embodiments of the thermionic converter according to the invention may have a cathode with a form and/or cross-section slightly different from that shown in FIG. 3.

For example, FIG. 2A shows a configuration of the converter similar to that of FIG. 2, but with the cathode 28 having a flattened (elliptical) cross-section.

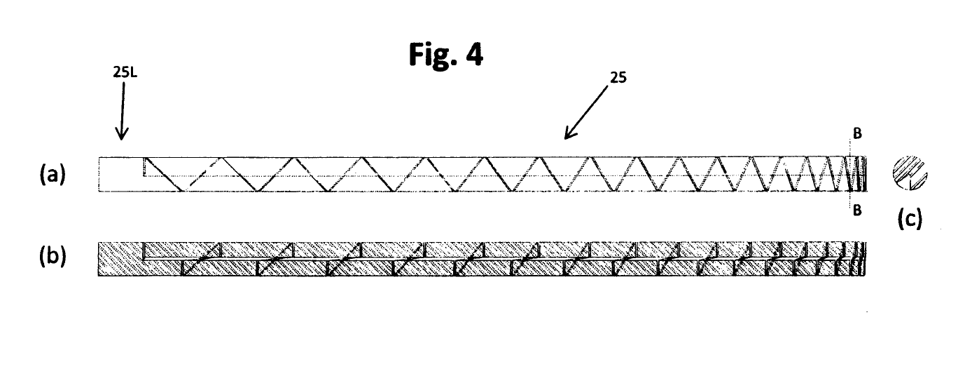

FIG. 4 shows a cathode 25 in the form of a cylindrical spiral used in a second embodiment of the thermionic converter according to the invention. In particular, the cathode 25 has a current output at one end and single-start variable-pitch winding, so that the cathode 25 passes out only from one of the ends of the vacuum tube 3 (left-hand end 25L) and is suspended (by means of suspension systems similar to the double-spiral systems illustrated for the cathode 24) and kept in the axial position of the tube 3 preferably by means of resilient ties, not shown (for example in the case of miniaturization of the device). The pitch of the cylindrical spiral decreases in the direction away from the suspended end 25L (i.e. towards the inside of the tube 3). The cathode has a variable conduction cross-section in order to compensate partially, by means of the increase in the number of turns, for the reduction in the intensity of the magnetic field generated by the conduction current along the length of the cathode itself, caused by the reduction in the said current due to the thermionic emission.

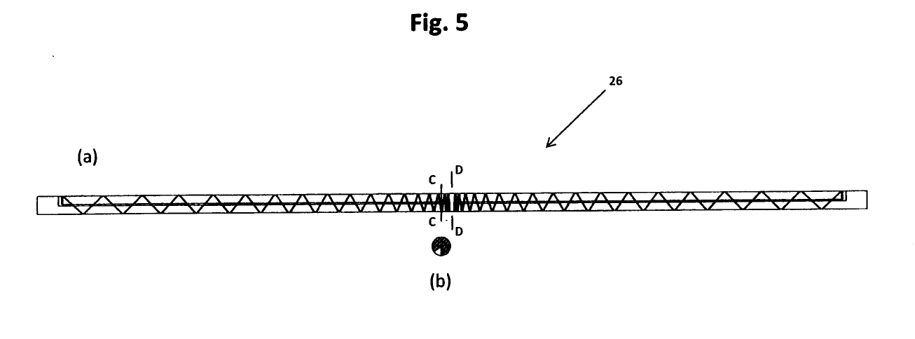

FIG. 5 shows a cathode 26 in the form of a cylindrical spiral used in a third embodiment of the thermionic converter according to the invention, preferably for currents of the order of 100 A or higher. In particular, the cathode 26 is symmetrical with respect to a middle transverse plane DD (which divides it into two mirror-image halves), has two current outputs at the two ends and an opposite single-start variable-pitch winding and is suspended (by means of suspension systems similar to the double-spiral systems illustrated for the cathode 24) and passes out from both the ends of the vacuum tube 3. The pitch of the cylindrical spiral decreases in the direction away from the two suspended ends towards the middle transverse plane DD. In a similar manner to the cathodes 24 and 25 shown in FIGS. 3 and 4, the cathode 26 is able to generate, by means of the conduction current passing through it, an axial magnetic field.

The cathodes 25 and 26 shown in FIGS. 4 and 5 may also be made in accordance with the manufacturing methods illustrated above for the cathode 24 according to FIG. 3.

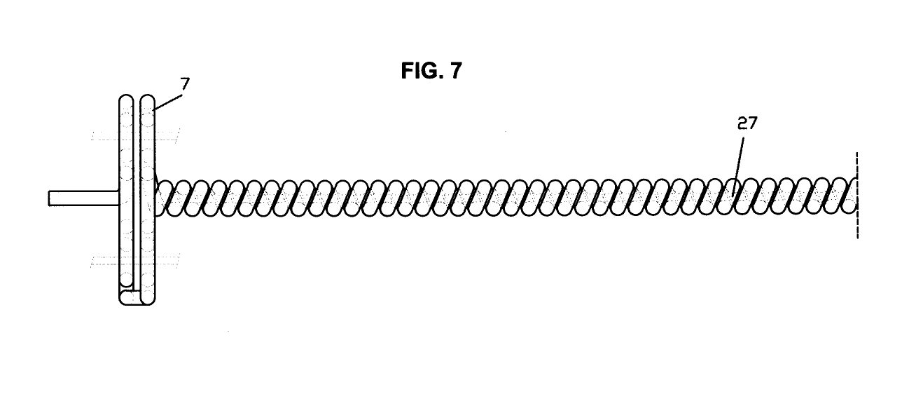

FIG. 7 shows a cathode 27 in the form of a single-start constant-pitch cylindrical spiral formed, not by machining of a solid cylinder, but by means of a wire wound by means of spiral bending, which operates in a manner similar to the cathode 24 according to FIG. 3 or the cathode 25 according to FIG. 4. In other words, the cathode 27 may be designed so as to operate as a cathode with a single output (as in the case of the cathode 25 according to FIG. 4), shown in FIG. 7 at the left-hand end, or as a cathode with a double output at the two ends (as in the case of the cathode 24 according to FIG. 3), by inverting the direction of winding in the middle of the device (as shown in the cathode 24 according to FIG. 3). Using the same wire the double suspension spiral 7 in FIG. 7 is formed by means bending, with winding in the same direction as that of the adjacent cathode for which it acts as a support. The cathode 27 is also able to generate, by means of the conduction current passing through it, an axial magnetic field, according to the invention.

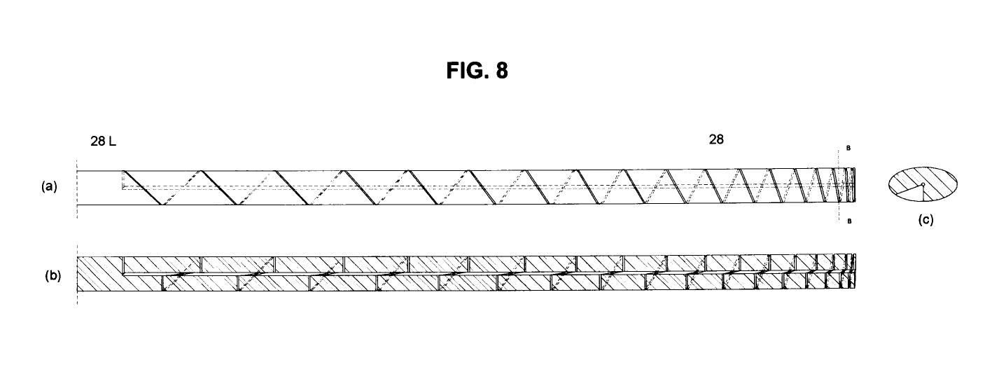

The cathodes 24, 25, 26 and 27 may have a spiralled form with a circular cross-section or also a flattened cross-section, for example an elliptical or other flattened form, spirally machined by means of one of the cutting methods already described above. This embodiment is shown for example in FIG. 8 (the elliptical cross-section is in particular shown in FIG. 8c). In the case of the flattened form, during assembly, the thermal expansion of the materials will be conveniently taken into account The person skilled in the art is able to calculate the deformations in order to obtain an optimum alignment between cathode and anode(s).

In the continuation of the description, when reference is made to the cathode of the thermionic converter according to the invention, the cathode 24 shown in FIG. 3 will be expressly indicated. It must, however, be understood that any descriptions provided are similarly applicable to and valid for the cathodes of the other embodiments of the thermionic converter according to the invention, such as the cathodes 25, 26, 27 and 28 in FIGS. 4, 5, 7 and 8, respectively, or other analogous or similar embodiments.

With reference again to FIGS. 2, 2A, it can be seen that, inside the tube 3, there is also housed longitudinally at least one anode, preferably (at least) one pair of anodes 6 (as in the embodiment shown in FIGS. 2, 2A and 6, 6A) flattened longitudinally and mounted diametrally relative to each other on the sides of the cathode advantageously provided in the form of tubes or pipes or such as to house metal cooling tubes or pipes 18 of any form and cross-section. In other words the anodes 6 have substantially two generally flat faces and are advantageously arranged laterally and edgewise with respect to the cathode 24, 28, namely in a minimum irradiation position, and pass out from the two ends of the vacuum tube 3 for the hydraulic and electrical connections, via resilient diaphragms 22, to which they are preferably integrally connected (e.g. welded) in a sealed manner and which keep them positioned laterally edgewise with respect to the cathode 24, 28 so that the two generally flat faces of each anode 6 act as active surfaces for absorbing the electrons. Advantageously the surfaces of said anodes may have a functional lining suitable for improving the electron absorption characteristics and/or a lining of barium or rare earths or lanthanum hexaboride, known per se, for reducing the working function of the anodes, or other functional linings. As mentioned, the two anodes 6 are advantageously provided with cooling means (in the embodiment shown in FIGS. 2, 2A and 6, 6A, consisting of metal cooling tubes or pipes 18) or perform at the same time the function of cooling means for performing the thermionic conversion cycle with the triple function of acting as electrodes for connection to the exterior, forming or supporting the surfaces of the conversion anodes 6 with a low view coefficient between cathode 24, 28 and anodes 6, and providing means (18) for performing cooling by means of circulation of a fluid, so as to cause the anodes 6 to operate at the lowest possible temperature, for example <400° C., preferably about 50-100° C. or less, optionally but not exclusively, the temperature being included in the liquid phase range of water or some other heat-carrier fluid, for example between 10° C. and 100° C. depending on and in keeping with the temperature available for the function of cooling the anodes 6, allowing at the same time recovery of the discarded heat for low-temperature uses such as the heating of water for sanitary use.

Preferably a magnet 8, or also more than one magnet, of the permanent deflection type, of any shape, is/are positioned inside or outside the device, preferably inside the anode or anodes 6, or on the surface of the anode or anodes 6, housed inside the cooling tubes 18, arranged preferably in two rows, so as to generate magnetic deflection fields.

One or more reflective screens 9 line the inner wall of the tube 3 acting as radiation screens known per se and consisting of a variable number of (preferably 19) thin reflective metal sheets, depending on the required insulation efficiency, for minimizing the energy dispersed by means of irradiation. The screens 9 are arranged concentrically along the perimetral inner surface of the tube 3, electrically connected to the exterior and separated from each other by empty spaces via suitable spacers (not shown), except for a longitudinal strip which forms the access window 4, for reflecting the radiation emitted by the cathode 24, back to the cathode 24, in order to reduce the losses due to irradiation externally and increase the efficiency at high temperatures.

Two further additional radiation reflective screens 31 may be mounted at the two ends inside the vacuum tube, being made of the same material as the first screen, with receiving holes for the cathode and the tubes of the anodes and being insulated from the latter and electrically connected to the internal screen of the cylindrical wall, so as to reflect the radiation in an axial direction and complete the electron containing chamber.

Furthermore, one or more grids known per se (indicated in FIG. 2, 2A by the reference numbers 10, 11, 13, 14, 15 and 16) may be arranged in various manners inside the vacuum tube 3, for generating electric fields for controlling operation of the thermionic converter, as will be described in greater detail further below.

One or more sockets 21, known per se, are present on the wall of the tube, for performing the electrical connections between the inside and outside.

The tube 3 also houses the discharge tube 19 known per se, mounted on a receiving flange or on the body of the vacuum tube 3.

The solar energy is concentrated on the cathode 24 by means of optical systems so as to increase it to a temperature suitable for triggering the thermionic emission.

The cathode 24 is connected to special support elements and resilient suspension means which keep it in position in the centre of the tube 3 and designed to maintain the relative position of the cathode 24 and the pair of anodes 6.

The surface of the cathode 24 may be advantageously treated in a manner known per se in order to increase the roughness thereof or provided with a conductive refractory lining in order to maximize the capture coefficient and minimize the reflection and emission factors, forming a selective surface, so as to increase the capture efficiency.

According to the embodiment shown in FIG. 2, 2A, two metal cooling tubes 18 are positioned alongside the cathode 24, 28, said tubes having dimensions suitable for the thermal power to be extracted, being flattened longitudinally and welded to two thermal and electrical conduction fins which form the capture surfaces of the anodes 6, with a cross-section which is thinner towards the cathode 24, 28, so as to form two flat surfaces inclined at about 9° with respect to each other and positioned edgewise laterally with respect to the cathode, being arranged symmetrically with respect to a plane passing along a diameter of the cathode 24, 28 (in the case of a pair of anodes 6, as in FIGS. 2, 2A and 6, 6A, the two flat surfaces of the two anodes are arranged symmetrically with respect to the same diametral plane), so as to offer a minimum exposure cross-section for obtaining a view coefficient between cathode 24, 28 and anodes 6 which is as low as possible in keeping with the cooling requirements; the view factor between cathode 24 and anode 6 for the configuration of the embodiment shown in FIGS. 2 and 3 is 0.048 for one surface of the anodes 6 which, added together for all the surfaces, gives a value of 0.19.

The capturing surfaces of the anodes 6 may be treated superficially with a lining which is designed to improve absorption of the electrons.

The tubes 18 and anodes 6 may be advantageously made of copper owing to the high electrical conductivity and high melting temperature characteristics and are mounted on pre-tensioned closing diaphragms 22 in order to compensate for a thermal expansion of about 2 mm at 100° C. for one metre of extension.

The tubes which form the anodes 6 are insulated either using an electrically insulating cooling fluid or an internal tube lining insulation and external insulating connections, so as to be able to use the tube itself as a conductor and electrical output connection 18, or using separate flanges and passages for the tubes and the electrical connections, so as to provide the electrical insulation, thus being able to use added water as cooling fluid.

These tubes are cooled with a circuit (not shown) for circulating cooling fluid at a temperature of about 70-80° C. which may be used for other purposes or may be cooled using passive means for keeping the anodes at a temperature of about 100° C.

The anodes 6 are connected electrically to the exterior via the same cooling tubes 18 which pass through the wall via suitable resilient flanges 22.

As mentioned above, one or more grids known per se (indicated in FIG. 2, 2A by the reference numbers 10, 11, 13, 14, 15 and 16) may be arranged in various manners inside the vacuum tube 3. It must be considered that these grids do not constitute essential characteristic features of the invention and may also not be at all present in the thermionic converter according to the invention.

In particular, one or more deflection grids 15, arranged in four—preferably symmetrical—positions in the four quadrants, may be present in the tube 3 in order to compensate for spatial charge which forms inside the tube 3.

Optionally the following further grids may also be present inside the tube 3:
one or more control grids 13, the presence of which is known in the art and which are arranged around the cathode 24;
one or more acceleration and deflection grids 14 which are arranged in four—preferably symmetrical—positions in the four quadrants;
one or more grids 16 for screening the field of the anodes 6, which are arranged in four—preferably symmetrical—positions in the four quadrants facing the anodes;
one or more containing grids 10 acting as reflective radiation screens;
one or more containing and deflection grids 11 which are arranged in four—preferably symmetrical—positions in the four quadrants.

These further grids (10, 11, 13, 14 and 16) are, as mentioned, optional and not strictly necessary.

All the above functional elements (except for the magnets 8) are electrically connected to the exterior separately, by means of a corresponding number of pins of the connection sockets 21, and are suitably positioned depending on the desired operating characteristics and are controlled, depending on the working characteristics and conditions, by suitable polarization circuits (not shown).

A pair of external mechanical suspension flanges (not shown) for stable positioning on the optical working point (optical focus) is also present.

The advantages provided by the present device include among others:
minimization of heat exchange due to irradiation between cathode 24 and anodes 6, favouring the heat exchange promoted by the electrons emitted from the cathode 24;
minimization of the heat exchange due to irradiation of the cathode 24 externally;
minimization of the heat exchange due to conduction, so as to raise the thermal efficiency and therefore the overall efficiency.

These advantages are obtained using at least one of the following solutions or two of them or preferably all three of them:
i) The anodes 6, each having a longitudinally flattened form comprising two faces, are positioned edgewise laterally with respect to the cathode, with the two faces arranged symmetrically with respect to a plane passing through a diameter of the cathode 24 (in the case of a pair of anodes 6, as shown in FIGS. 2 and 6, 6A, the two flat faces of the two anodes are arranged symmetrically with respect to the same diametral plane) instead of frontally facing as in the prior art, with the tangents to the facing surfaces of an anode 6 and cathode 24 such as to form angles ranging between 70° and 180°, but not exclusively so, in particular in the case of the cylindrical cathode in the example, the view angle varies between 85° and 174°, depending on the portion of circular surface considered, being preferably close to 180°, so that at least one plane of symmetry of each component lies in the same plane of symmetry of at least another different one of these electrodes (if one is a cathode, the other is an anode) and in such a way that the view angle of each surface of the cathode 24 and anode 6 is as wide as possible, tending towards 180°, so as to obtain in this way a low heat exchange between cathode 24 and anodes 6 due to the low view coefficient between the respective surfaces. This angle, which must be as close as possible to 180°, depends on the dimensions of the cooling tubes 18 and the conduction cross-section of the cathode 24 and is necessary in order to contain internally the cooling tubes 18 in thermal contact with the anodes 6 and allow housing of the deflection magnets 8 and a suitable conduction cross-section of the cathode.
ii) The cathode 24 is electrically connected by means of double-spiral conductors 7 so as to increase the length of the heat conduction path and limit the associated heat losses due to conduction via the electric terminals which connect it to the exterior.
iii) The entire perimetral inner surface of the tube 3 is lined with a reflective layer which is deposited on the wall, preferably formed by a thin reflective metal sheet, or more than one reflective layer, preferably 7 layers (87.5%), even better 19 layers, thus reaching 95% efficiency of the screens, acting as radiation screens, known per se, arranged concentrically, separated by empty spaces via suitable spacers, except for a longitudinal strip situated along and able to define the access window 4 through which the concentrated solar light beam enters at an opening angle which can be easily defined, preferably between 10° and 60°, more preferably between 10° and 45°, and even more preferably between 10° and 40°. The first internal layer of the radiation screens may consist of a cylindrical mirror (not shown) deposited on an electrically insulating substrate, or deposited directly on the inner wall of the vacuum tube 3, arranged in a manner known per se concentrically along the inner surface parallel to the axis of the vacuum tube 3, except for the longitudinal strip of the access window 4, so as to reflect the radiation emitted by the cathode 24, back onto the cathode 24, in order to reduce the losses due to irradiation externally and increase the efficiency at high temperatures and electrically insulate the rear side so as to limit the possible thermionic emission of the first layer of the screen towards the successive screening layers. This mirror may be advantageously formed, alternatively, by a metal cylinder which is mirror-polished or provided with a mirror effect by means of deposition of a reflective layer, with the external surface treated by means of application of an electrically insulating layer which may be formed as a layer of oxide of the same metal or by means of deposition of an insulating refractory layer or by means of superficial vitrification or other insulating treatment known per se, with the same form, the same functions and the same arrangement as that described above.

Being positioned inside the vacuum tube 3 with a concentric arrangement, these screens will reflect the radiation irradiated by the cathode 24 in the most efficient manner possible, back to the centre and onto the cathode 24. It is thus possible to obtain efficient thermal insulation of the cathode 24 for the screened part which may range from 77% to 84% of the total irradiation or even greater.

Two further reflective screens 31 in the form of a disc may be mounted at the two ends inside the vacuum tube, being made of the same material as the first screen, with receiving holes for the cathode and the tubes of the anodes, being insulated from the latter and connected electrically to the internal screen of the cylindrical wall, so as to reflect the radiation in an axial direction.

### Operation

Although not limited necessarily to use with sunlight, being able to be exposed to radiation from other sources, below operation of the thermionic converter will be illustrated with reference to exposure to sunlight.

By means of the direct light of the sun, the surface of which has a temperature of 5500° C., it is possible to obtain a peak thermodynamic cycle at temperatures of about 3000° C. which can be withstood by refractory materials such as tungsten (melts at 3387° C.) and graphite (sublimates at 3600° C.), allowing high efficiency levels to be achieved.

With reference to FIGS. 1-8, the light is concentrated onto the cathode 24 in the form of a cylindrical spiral of a high-vacuum tube 3 by flat/parabolic mirrors 2 or other optical systems at a ratio with an order of magnitude of 1:100.

The cathode 24 has the function of capturing the solar radiation and emitting electrons for thermionic emission. In order to maximize the capturing function, the surface is treated so as to make it porous and non-reflective and/or lined with a selective carbon lining known per se having a low emission and high absorption factor. The cathode 24 is mounted at the centre of a system of reflective screens arranged internally along the wall of the tube 3, except for a segment 4 which is left free for entry of the light, at a distance such as not to cause excessive overheating of the reflective layers and prevent deformation thereof. The tube 3 may have a theoretical cross-section with a diameter, ranging, by way of example, but not exclusively, between 100 mm and 250 mm. At both the ends of the cathode 24 longer paths are provided for the output terminals, made of the same material as the cathode 24, so as to reduce the heat losses due to transmission and lower the temperature of the output terminals in the zone passed through by the closing diaphragm 23. These paths are formed using a solid disc which is cut almost completely thickness-wise so as to provide two parallel discs which are joined along a section close to the edge and spirally machined by means of milling or some other per se known electrical, optical or chemical machining operation or by means of sintered pre-forming. This form allows expansion of the material, which for tungsten at 3000° C., corresponds to about 15 mm/m. In the case of linear expansion of 15 mm/m it is sufficient to mount the cathode 24 by pre-tensioning the resilient support elements so as to leave, in the example shown, a gap of about 10 mm on either side between the central zones of two spiral discs. In the case where the intensity of the mechanical tension generated by the pretensioning may not be withstood by the resilient diaphragms or by the containing tube, it may be discharged onto the anodes by means of an electrically insulated mechanical connection element 30, or a cathode emerging from a single end may be opted for. This element 30 may also act as a heat bridge for management of the heat flow between the terminal of the cathode and the following anode (of two respective converters connected in series) in order to manage the Peltier and Seebeck effects due to the thermal or electrical flow on terminals made of different metals.

The energy emitted by the cathode 24 via irradiation is reflected and concentrated back onto the cathode so as to limit effectively the losses due to irradiation, which are considerable at these temperatures. In the case of a system of screens with 19 layers the efficiency of the screens is 95% and applies to a segment of 320°, the part covered by the screens, which constitutes 89% of the total surface of the inner wall of the vacuum tube 3, resulting in a screening efficiency of 84% for the application.

The screens also have an electrical function: the vacuum tube 3 forms an expansion chamber for the electrons emitted by the cathode 24 and the negatively charged screens form the containing walls thereof so that the energy electrons emitted by the cathode 24 are deflected and reflected by the electrical field and cannot strike them, causing them to overheat. For this purpose, two additional screens 31 in the form of a disc may be further mounted, opposite the suspension spirals, being positioned between these and the anodes and connected electrically to the other screens so as to complete the electron expansion chamber in the axial direction.

The polarization of these screens, which behave electrically in the manner of a capacitor, may be left to the electrostatic charge which accumulates initially, due to the first impacts, controlling the maximum voltage thereof externally so as to keep it below the emission voltage of the electrons of the material which forms them at the equilibrium temperature of the said screens. For this purpose, the screens are electrically connected to a pin of the socket 21 of the electrical connections. Materials suitable for the first internal layer of the screens are nickel, iron, chromium or molybdenum for the high melting temperature and the high working function, allowing operation at a higher negative polarization voltage and temperature, before electron emission commences. Alternatively, as a first reflective layer, a cylindrical mirror may be inserted, said mirror being made with a reflective layer deposited on glass or on some other refractory insulating substrate, except for a longitudinal strip which forms the access window 4, in order to improve the reflection of the first layer and prevent the thermionic emission thereof towards the successive outer-lying layers. The other screens may be formed with glossy aluminium sheets. A suitable polarization voltage could be in the region of −20V referred to the cathode 24, but the optimum value will be defined by means of measurement of the polarization curves of the component and may vary depending on the geometrical form and other characteristics of the device.

Moreover, the cathode 24 in the form a cylindrical spiral generates an axial magnetic field which is useful for deflecting the electrons emitted by the cathode itself towards the anodes 6 arranged diametrally. The double-spiral form of the suspension conductors of the cathode 24 also contributes to this axial magnetic field.

The anodes 6 are composed of two metal profiles inside which the cooling pipe 18 passes. They are arranged laterally parallel to the cathode 24, edgewise so as to have a view coefficient, with respect to the cathode 24, which is as low as possible. The view coefficient between anodes 6 and cathode 24 in the arrangement shown in FIG. 2 is 0.29 which corresponds to 19%. The cooling tubes 18 of the anodes 6 which also act as electrical connections pass out through the resilient diaphragms 6 from the side walls and must be connected to the cooling system and to the electrical connection cables. The cooling tubes 18 may house, inside them, a row of permanent magnets 8 with aligned magnetic fields, oriented antiparallel and equidistant, so that the field lines in the spaces between them are arranged as far as possible horizontally and parallel to the surface of the anodes 6, except in the region of the poles. This assists further deflection of the electrons orthogonally in relation to the flow lines, favouring the impact with the surface of the anodes 6 or routing and capturing towards the poles.

When all the grids described above are present, the pair of control grids 13 arranged close to the surface of the cathode 24 has a slightly negative polarization compared to the cathode 24 (for example −1 V) so as to select the electrons with energy greater than average and screen at the same time the field of the cathode 24 which, emitting electrons, assumes a positive charge and would tend to slow down and attract back the electrons being emitted. (The voltages below will be indicated with respect to the potential of the cathode 24). The electrons, once they have passed beyond the first grid, will tend to spread within the space around the cathode 24, becoming less dense towards the walls of the tube 3 owing to the negative electric field of the walls, forming a spatial charging zone. In order to compensate for the spatial charge formed, the second and third series of deflection grids 14 and 15 are used, being polarized for this purpose by an external generator to a positive voltage value. Since this grid 14 and the following deflection grids 15 are positively polarized, they capture electrons and therefore use energy. The voltage value of the grid 14 and the series of following deflection grids 15 is determined on the basis of the power percentage which is to be used and could reach a figure of about +10V, for the deflection grid 14, and about +15V for the deflection and spatial charge compensation grid 15. An acceptable compromise is to use 10% of the power output for this use. A further system of grids, the fourth one, is arranged around the anodes 6 and is polarized to the voltage of the cathode 24 acting as a screen for the negative charge of the anodes 6. It is assumed that it is possible to obtain an operating voltage of the device ranging between 1V and 5V, but the optimum voltage must be determined by means of an analysis of the operating curves in order to obtain the maximum conversion efficiency, using methods known to the person skilled in the art.

A last grid system may thus be positioned as follows: two on the sides of the anodes 6 and two axially aligned with the cathode 24; the first pair reflects the electrons which rebound on the anodes 6; the second pair deflects laterally the electrons which are emitted in axial alignment with the cathode 24. The latter pair is negatively polarized. In reality, none of the grids described above is strictly necessary, and other thermionic converters according to the invention may comprise only the spatial charge compensation grid 15 or may not comprise any grid or also may use ionized caesium vapours for neutralization of the spatial charge according to known methods.

With reference to FIG. 1, the object proposed is to provide a device 1 which is able to produce about 1000 W per linear metre of extension using mirrors 2 with an opening of 2.5 m. With a working voltage of 1V, currents of 1000 A per m must be managed, whereby the device 1 is to be divided up into several shorter elements owing to the need to increase excessively the conduction cross-section of the cathode 24 and the output terminals. In this condition, with the proposed configuration shown in FIG. 1, in the case of a length of 1 metre, the emitted current density required is:
1000 A/706 cm̂2=1.42 A/cm̂2, in keeping with the saturation emission density of tungsten at 2500° C. which is 2.9 A/cm̂2 and well in keeping with the possibility of raising the working voltage by increasing the temperature to 3000° C. corresponding to a saturation current of 72 A/cm̂2. Even more advantageous will be operation with an increase of the output voltage, requiring lower operating currents.

The calculation example demonstrates that the device according to the invention provides optimum working conditions also and in particular in the case of low emission densities.

### Example of Evaluation of the Total Efficiency According to an Embodiment of the Device of the Invention, Considering the Various Losses and the Associated Efficiency Values.

The solar radiation, in order to be collected, first strikes the concentration mirrors 2 with an efficiency of 90% and then the glass wall of the window 4 which has an efficiency of about 92%, resulting in a combined efficiency factor hitherto of 0.83.

The capture losses on the cathode 24 may be estimated at about 5%, with a capture efficiency therefore of 95% and a combined efficiency factor of 0.79. The theoretical thermodynamic efficiency of the equivalent Carnot cycle at these temperatures (3000° C. for the cathode 24, 100° C. for the anodes 6) reaches a figure of 88.6%, giving a combined efficiency factor of 0.70. From this the following are then subtracted: the losses due to irradiation between cathode 24 and anodes 6 (which can be estimated at 19%), the losses due to irradiation through the inlet window 4 (which can be estimated at 11% for the configuration proposed), the losses due to irradiation through the radiation screens (which can be estimated at 4%), giving a total irradiation loss of 34%, and an insulation efficiency of 66%, resulting in a combined efficiency factor of 0.46. In addition it is required to consider the losses due to heat conduction on the electric terminals of the cathode 24 (which can be estimated at 5%) with a combined efficiency factor totalling hitherto 0.44; the conversion losses due to spatial charging and to polarization of the grids (which can be estimated at 10%) with a combined efficiency factor of 0.40, the electrical losses due to the Joule effect along the electrical connections (which can be estimated at 15%), giving ultimately a total estimated electrical efficiency of 34% for the system. Estimating a heat recovery of about 5% via the tubes for cooling the heat discarded from the Carnot cycle, 5% for the losses due to heat conduction and 5% for the electrical losses (losses due to the Joule effect on the anodes), it is possible to calculate a cogeneration recovery value of about 15% by way of thermal energy which, added to the electrical efficiency, results in a total efficiency of the working plant which may be estimated at a figure close to 49%, but may also be higher in the case where the grids are eliminated.

To summarize: 90% efficiency of the mirrors; 38% electrical efficiency of the converter; 15% heat recovery; giving a total estimated efficiency of the plant equal to 49%. This efficiency figure is extremely high when compared to that of commercial photovoltaic panels which reaches at the most 14-15%, with much larger surface dimensions.

All the dimensions may be determined by the person skilled in the art, who is able to realize the invention with reference to the text and the illustrations shown in the figures.

The invention claimed is:

1. A thermionic converter with a linear component arrangement, configured for direct conversion of solar energy into electrical energy and for combined generation of heat and energy, comprising:
an elongated vacuum tube (3) which houses a cathode (24; 25; 26; 27; 28) and at least one anode (6), the cathode (24; 25; 26; 27; 28) and said at least one anode (6) being arranged longitudinally alongside each other along the elongated vacuum tube (3),
wherein the cathode is suspended centrally inside the tube (3) at at least one end (25L) of the cathode, the at least one end forming at least one current output of the cathode (24; 25; 26; 27; 28), and
wherein the cathode is a cathode in form of a spiral.

2. The thermionic converter according to claim 1, wherein the cathode is a cathode (24) in form of a cylindrical spiral with an opposite double-start constant-pitch winding, the cathode being suspended at two ends which form two current outputs of the cathode (24).

3. The thermionic converter according to claim 1, wherein the cathode is a cathode (25) in form of a cylindrical spiral with a single-start variable-pitch winding, the cathode being suspended at one end (25L) which forms one current output of the cathode (25), wherein the pitch of the winding decreases in a direction away from said end (25L) which forms the current output of the cathode (25).

4. The thermionic converter according to claim 1, wherein the cathode is a cathode (26) in form of a cylindrical spiral with an opposite single-start variable-pitch winding, the cathode (26) being symmetrical with respect to a middle transverse plane (DD), the cathode being suspended at two ends which form two current outputs of the cathode (26), wherein the pitch of the winding decreases in a direction away from each of said two ends which form the current outputs of the cathode (26) towards the middle transverse plane (DD).

5. The thermionic converter according to claim 1, wherein the cathode is a cathode (27) in form of a cylindrical spiral with an opposite single-start or double-start constant-pitch winding, the cathode being suspended at one or two ends which form two current outputs of the cathode (27) and being integrally joined to a double spiral (7).

6. The thermionic converter according to claim 1, wherein the cathode is a cathode in form of a flattened spiral.

7. The thermionic converter according claim 1, wherein said at least one anode (6) has a longitudinally flattened form so as to form two flat surfaces inclined with respect to each other and arranged symmetrically with respect to a plane passing through a diameter of the cathode (24; 25; 26; 27; 28).

8. The thermionic converter according to claim 1 wherein the cathode (24; 25; 26; 27; 28) and said at least one anode (6) are arranged relative to each other in a minimum irradiation position.

9. The thermionic converter according to claim 1, wherein the cathode (24; 25; 26; 27; 28) and said at least one anode (6) have a relative arrangement with a view factor of between 0.001 and 0.35.

10. The thermionic converter according to claim 1, further comprising one or more deflection magnets (8).

11. The thermionic converter according to claim 1, wherein said at least one anode (6) comprises a tube (18) designed to be passed through by a cooling fluid.

12. The thermionic converter according to claim 1, wherein the cathode (24; 25; 26; 27; 28) is suspended at the at least one end (25L) by a conductor electrically connected to said at least one end (25L) and comprising two spirals (7) with winding directions which coincide with and are in a same direction as said at least one end (25L) to which said conductor is connected.

13. The thermionic converter according to claim 1, wherein an inner wall of the elongated vacuum tube (3) is lined with a radiation screening (9) provided with an access window (4).

14. The thermionic converter according to claim 1, further comprising grid electrodes (10, 11, 13, 14, 15, 16) which are designed to generate electric fields.

15. An optical system for concentrating energy, comprising;
a plurality of converters according to claim 1 arranged in aligned units and connected together by one or both of hydraulic or electrical connections.

16. The optical system for concentrating energy according to claim 15, wherein the optical system is operatively coupled to a heat recovery system for low-temperature applications.

17. The thermionic converter according to claim 7, wherein the elongated vacuum tube (3) houses at least one pair of anodes (6) in which the two flat surfaces of the two anodes of each pair are arranged symmetrically with respect to a same plane passing through a diameter of the cathode (24; 25; 26; 27; 28).

18. The thermionic converter according to claim 9, wherein the view factor is between 0.001 and 0.03.

19. The thermionic converter according to claim 10, wherein the one or more deflection magnets (8) are housed inside said at least one anode (6).
